(19) United States
(12) Patent Application Publication
(10) Pub. No.: US 2025/0231724 A1
(43) Pub. Date: Jul. 17, 2025

(54) HOLOGRAPHIC STREAMING MANAGEMENT SYSTEM

(71) Applicant: Holographic Amusements LLC, Garden City, NY (US)

(72) Inventors: Joe Mohen, Garden City, NY (US); Orville L. Hagler, Brooklyn, NY (US); Jacques Krischer, Couze-et-Saint-Front (FR)

(73) Assignee: Holographic Amusements LLC, Garden City, NY (US)

(21) Appl. No.: 18/572,761

(22) PCT Filed: Sep. 19, 2023
(86) PCT No.: PCT/US2023/033188

§ 371 Date: Dec. 20, 2023

Related U.S. Application Data
(60) Provisional application No. 63/390,596, filed on Jul. 19, 2022.
(60) Provisional application No. 63/411,527, filed on Sep. 29, 2022.

(51) Int. Cl. G06F 3/14; G10L 19/018; G11B 27/24

(52) U.S. Cl. CPC G06F 3/14; G10L 19/018; G11B 27/24

(57) ABSTRACT

Systems and methods are disclosed for a holographic streaming management system. In one implementation, a first media content item is received. Metadata tag(s) are associated with the first media content item. Based on one or more metadata tag(s), the first media content item is selected for presentation at a first holographic presentation device. The selected first media content item and a content presentation file associated with the first holographic presentation device are transmitted to the first holographic presentation device. Input(s) corresponding to a presentation of the first media content item via the first holographic presentation device are received. Based on the received input(s), aspect(s) of a transmission of a second media content item to the first holographic presentation device are adjusted.

### PRIORITY CLAIM

This application is related to and claims the benefit of priority to U.S. Patent Application No. 63/390,596, filed Jul. 19, 2022, and U.S. Patent Application No. 63/411,527, filed Sep. 29, 2022, each of which is incorporated herein by reference in its entirety.

### TECHNICAL FIELD

Aspects and implementations of the present disclosure relate to data processing, content management, and content presentation. More specifically, but without limitation, aspects and implementations of the present disclosure relate to holographic streaming management systems.

### BACKGROUND

A hologram is a recreation of a person, animal, plant, or object. The word hologram derives from the Greek words holos (whole) and gramma (message). Whereas a conventional motion picture is a set of two-dimensional moving pictures, a hologram is a three-dimensional moving picture intended to create the illusion that the person or object of the depiction is actually present in the same place as the viewer.

Like conventional movies, holograms can be recorded with special purposes, or in other cases created with computer animation, or a combination of both. Holograms can be recorded in advance and stored in a library, or they can be streamed in real time. While early holograms required specially designed headgear or glasses to see, newer holograms can be made such that they are visible to the naked eye without visual or mechanical assistance.

Holograms can be created in diverse ways depending upon the type of device or three-dimensional cinematic stage upon which they are to be displayed. These include three-dimensional television displays, stages with angular reflectors which are derivative of peppers ghost type of projection, or even the manipulation of the photons themselves to create light fields.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 depicts further aspects of the referenced system, in accordance with various embodiments.

FIG. 3 depicts an example graphical user interface (GUI), in accordance with various embodiments.

FIG. 4 depicts another example GUI, in accordance with various embodiments.

FIG. 5 depicts another example GUI, in accordance with various embodiments.

FIG. 6 depicts another example GUI, in accordance with various embodiments.

FIG. 7 depicts another example GUI, in accordance with various embodiments.

FIG. 8 depicts another example GUI, in accordance with various embodiments.

FIG. 9 depicts another example GUI, in accordance with various embodiments.

FIG. 10 depicts another example GUI, in accordance with various embodiments.

FIG. 11 depicts another example GUI, in accordance with various embodiments.

FIG. 12 depicts another example GUI, in accordance with various embodiments.

FIG. 13 depicts another example GUI, in accordance with various embodiments.

FIG. 14 depicts another example GUI, in accordance with various embodiments.

FIG. 15 depicts another example GUI, in accordance with various embodiments.

FIG. 16 depicts another example GUI, in accordance with various embodiments.

FIG. 17 depicts another example GUI, in accordance with various embodiments.

FIG. 18 depicts another example GUI, in accordance with various embodiments.

FIG. 19 depicts further aspects of the referenced system, in accordance with various embodiments.

FIG. 20 depicts further aspects of the referenced system, in accordance with various embodiments.

FIG. 21 depicts further aspects of the referenced system, in accordance with various embodiments.

FIG. 22 depicts further aspects of the referenced system, in accordance with various embodiments.

FIG. 23 depicts further aspects of the referenced system, in accordance with various embodiments.

FIG. 24 depicts further aspects of the referenced system, in accordance with various embodiments.

FIG. 25 depicts further aspects of the referenced system, in accordance with various embodiments.

FIG. 26 is a flow chart illustrating aspects of method(s) for holographic streaming management, in accordance with example embodiment(s).

FIG. 27 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to holographic streaming management system.

Recorded holograms can be stored as media file(s). These files can embed recordings of both the sound and of the video, the latter including information needed to render that video in three dimensions. Since these files can contain both video and audio they are referred to as multimedia files, or simply multimedia.

Other information can be included in such a media file. Such information can, for example, further describe the recording such as the name of hologram, the owner, the owners of intellectual property included in the video such as the music, the actors, recording artists who perform any music, companies that have any rights, the production team that made the hologram, and any other production credits. This information can be referred to as metadata.

Streaming media is multimedia that is delivered and viewed in a continuous manner from a source. Holographic media files require that they be viewed on a holographic display, on a holographic cinema stage, or be seen with holographic emitters. Streaming refers to the delivery method rather than the content itself. The delivery method from the multimedia can be telecommunications networks or a broadcast over terrestrial airwave. Traditional media delivery systems are either inherently streaming like radio or over the air like television or require physical delivery.

Holographic streaming can also include local area network streaming within a building or campus environment since holographic media files are often exceptionally large and pose challenges with streaming on the internet (especially when an internet connection lacks sufficient bandwidth which can result in stops, lags, or poor buffering of the content). Holographic streaming with a fast local area network allows holograms to be displayed without pauses and appear more lifelike. However, existing technologies are not capable of enabling hologram streaming in a manner that enables robust content management (e.g., with respect to intellectual property held by numerous parties) and also accounts for differences and dynamic changes across content presentation devices, platforms, and settings (each with their own technical and contextual considerations).

Accordingly, described herein in various implementations are technologies that enable holographic streaming management system and other related operations. Using the described technologies, media content can be processed and associated with metadata tags. Such media can then be dynamically transmitted (e.g., streamed), under appropriate conditions, to various holographic presentation devices, together with appropriate drivers, codecs, etc., that correspond to such devices. The described technologies can also track the presentation of such content (e.g., to enable content owners to collect corresponding royalties, adjust future deployments, and perform various other operations).

It can therefore be appreciated that the described technologies are directed to and address specific technical challenges and longstanding deficiencies in multiple technical areas, including but not limited to content management, delivery, and rights management. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

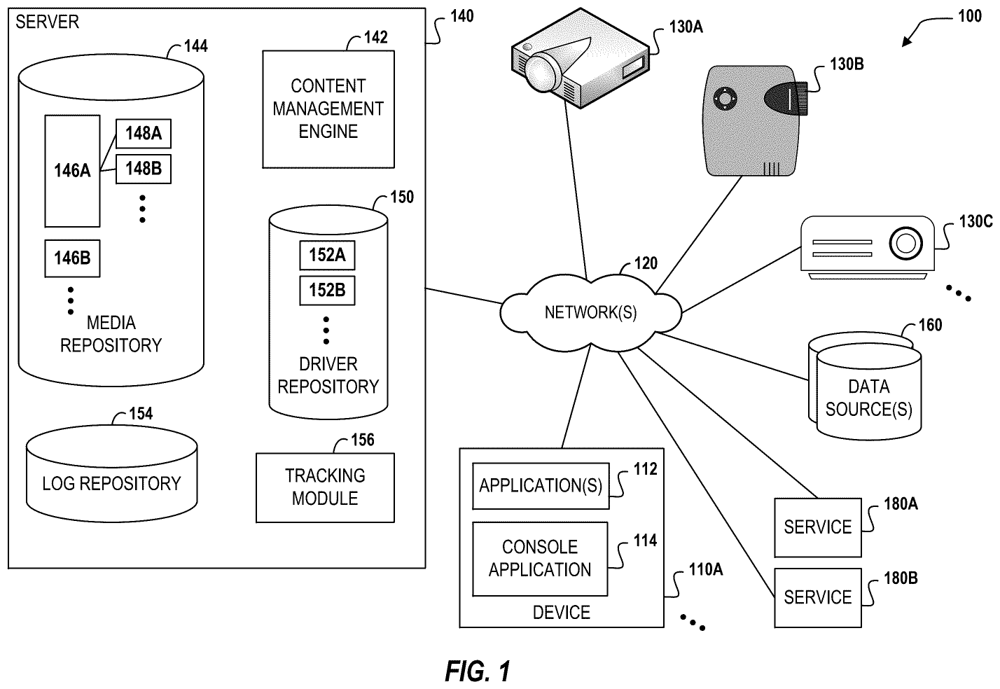

FIG. 1 illustrates an example system 100, in accordance with some implementations. System 100 can be, for example, a holographic streaming management system (“HSMS”) which can contain, include, or otherwise incorporate elements or components configured to deploy and manage the use of holographic images, e.g., in entertainment, scientific, or other such settings. As described herein, in certain implementations, such a system can enable the management, control, and/or automation of the display of holograms in venues such as a tourist attraction, campus, laboratory, or network of display devices.

As shown, system 100 includes components such as devices 110A, 110B, etc. (collectively, “devices”). Each of the referenced devices 110 can be, for example, a smartphone, a mobile device, a tablet, a personal computer, a terminal, a smart watch, a wearable device, a digital music player, a connected device, a server, and the like.

Human users can interact with respective device(s). For example, a user can provide various inputs (e.g., via an input device/interface such as a touchscreen, keyboard, mouse, microphone, etc.) to the referenced device(s). Such device(s) can also display, project, and/or otherwise provide content to users (e.g., via output components such as a screen, speaker, etc.).

As shown in FIG. 1, the referenced device(s) can include one or more application(s) 112, 114, etc. Such applications can be programs, modules, or other executable instructions that configure/enable the device to interact with, provide content to, and/or otherwise perform operations on behalf of a user.

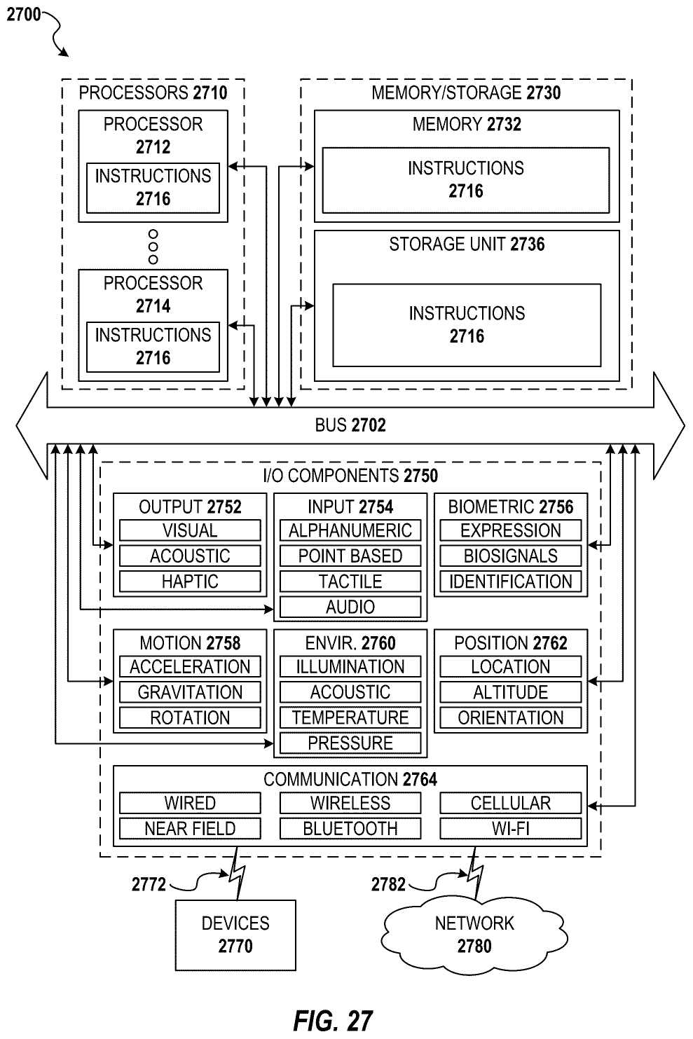

For example, application(s) 112 can include but are not limited to internet browsers, mobile apps, social media applications, personal assistant applications, content delivery applications, etc. These and other application(s) can be stored in memory of a device 110 (e.g., memory 2730 as depicted in FIG. 27 and described below). One or more processor(s) of the device (e.g., processors 2710 as depicted in FIG. 27 and described below) can execute such application(s). In doing so, the device can be configured to perform various operations, present content to a user, etc., as described herein.

As also shown in FIG. 1, device(s) 110 can be configured to execute other application(s) such as console application 114. Console application 114 can be an application that executes on device 110A and enables the device to interact with server 140, devices 130, various other machines, and/or to perform various operations described herein.

In certain implementations, application 114 can enable a user, administrator, manager, etc. to configure various aspects of the operations of system 100. In doing so, the described technologies can facilitate the presentation of holographic media content via multiple content presentation devices 130, e.g., in a manner that accounts for the capabilities of such devices and the rights of the owners of the holographic media content, as described in detail herein.

It should be noted that while the described application(s) 112, 114 are depicted and/or described as operating on a device (e.g., device 110), this is only for the sake of clarity. However, in other implementations such elements can also be implemented on other devices/machines. For example, in lieu of executing locally (e.g., at device 110A as shown in FIG. 1), aspects of such application(s) can be implemented remotely (e.g., on a server device or within a cloud service or framework).

As also shown in FIG. 1, device(s) 110 can connect to and/or otherwise communicate with other machines. For example, device(s) 110 can communicate with server 140 and/or various other servers, devices, services, etc., such as are described herein. Such communications can be transmitted and/or received via various network(s) 120 (e.g., cloud environments, the Internet, a wide area network (WAN), a local area network (LAN), a virtual private network (VPN), an intranet, and the like), communication protocols (e.g., Wifi, cellular, Bluetooth), etc.

Server 140 can be, for example, a server computer, computing device, storage service (e.g., a ‘cloud’ service), etc. that receives media content 146 (e.g., holographic media content), processes such content (e.g., to associate metadata 148), and manages the transmission/presentation of such content (e.g., at various holographic presentation venues), as described herein.

As shown in FIG. 1, server 140 can be configured to communicate with, interact with, transmit instructions to, and/or otherwise control aspects of the operations of content display devices 130A-130C. As described herein, such content display devices 130 can be holographic projectors, emitters, or other such devices capable of projecting or otherwise presenting holographic content, such as that stored and/or provided by server 140.

In certain implementations, server 140 can include content management engine 142. Content management engine 142 can be an application, module, instructions, etc., that configures/enables the server to perform various operations described herein. For example, in certain implementations, content management engine 142 can process media content 146 (and/or its associated metadata 148), facilitate the transmission of such content (e.g., to content presentation devices 130), and perform various other operations such as those described herein.

As also shown in FIG. 1, server 140 can include various repositories including media repository 144, driver repository 150, and log repository 154. Such repositories can be storage resource(s) such as object-oriented databases, relational databases, decentralized or distributed ledgers (e.g., blockchain), etc. As described herein, content management engine 142 and/or other components can interact with such repositories to adjust the operation of server 140, devices 130, other machines, and/or perform other operations such as are described herein.

In certain implementations, the holograms deployed and/or controlled by system 100 can be stored as media files 146, e.g., in a library or media repository 144, such as is shown in FIG. 1. Such repositories can be storage resource(s) such as object-oriented databases, relational databases, decentralized or distributed ledgers (e.g., blockchain), etc. As described herein, content management engine 142 and/or other components can interact with such repositories to perform various operations (e.g., with respect to the transmission and/or presentation of holographic media).

For example, system 100 can “ingest” holographic media files 146 into library 144 (e.g., in an orderly way). Such media 146 can then be retrieved from the referenced library, e.g., in order to stream the hologram to a location where it will be displayed and/or observed by an audience, as described herein.

In certain implementations, system 100 can also generate and/or maintain log files or audit trails, which can be stored in log repository 154. Such logs, files, etc. can, for example, enable further determinations concerning what payments are owed to rights owners (e.g., owners of the rights of certain elements of media 146), as well as other information about how often particular holograms are used or played, and how successful they are (e.g., based on various metrics).

System 100 can also include or incorporate a repository 150 of component device driver or set of drivers 152 for various types of holographic projectors, emitters, and/or other such devices 130 capable of displaying or otherwise depicting holographic content. Doing so can enable the described technologies to transmit and/or otherwise present holographic content in conjunction with hardware specific code, codecs, etc. 152 (which can be inserted or otherwise associated with the media files 146A transmitted to the content presentation device 130). In doing so, the described technologies can ensure that the three-dimensional video 146 renders properly on the holographic cinema stage or device 130. That is, it can be appreciated that multiple content presentation devices (e.g., device 130A, device 130B, etc., as shown in FIG. 1) can be used to render a hologram 146A, and each of these device 130 can be configured to require code, a codec, etc., 152 to stream such holograms to that specific device or set of devices (and that can also specify a venue for display of the hologram such as stage or identified location). Accordingly, in certain implementations, the same hologram 146A, when streamed to content presentation device 130A, can be streamed with codec 152A (as stored in repository 150), while the same hologram 146A, when streamed to content presentation device 130B, can be streamed with codec 152B. In doing so, the described technologies can optimize the presentation of such holographic content for the specific device at which it is being presented.

Additionally, in certain implementations system 100 can utilize the specific driver 152 that is operably linked to a specific emitter or set of emitters 130 to ensure that the hologram renders properly. The described technologies can be further configured to monitor the rendering/presentation of the hologram over time for any parameter function as noted herein including quality, location, duration, scheduling, or catalogue of digital rights associated with a hologram or plurality of holograms. Based on such monitoring (e.g., by receiving inputs/feedback originating from optical sensors embedded in such content presentation devices 130) the described technologies can, for example, adjust aspects of the display, depiction, streaming, etc., of such a hologram.

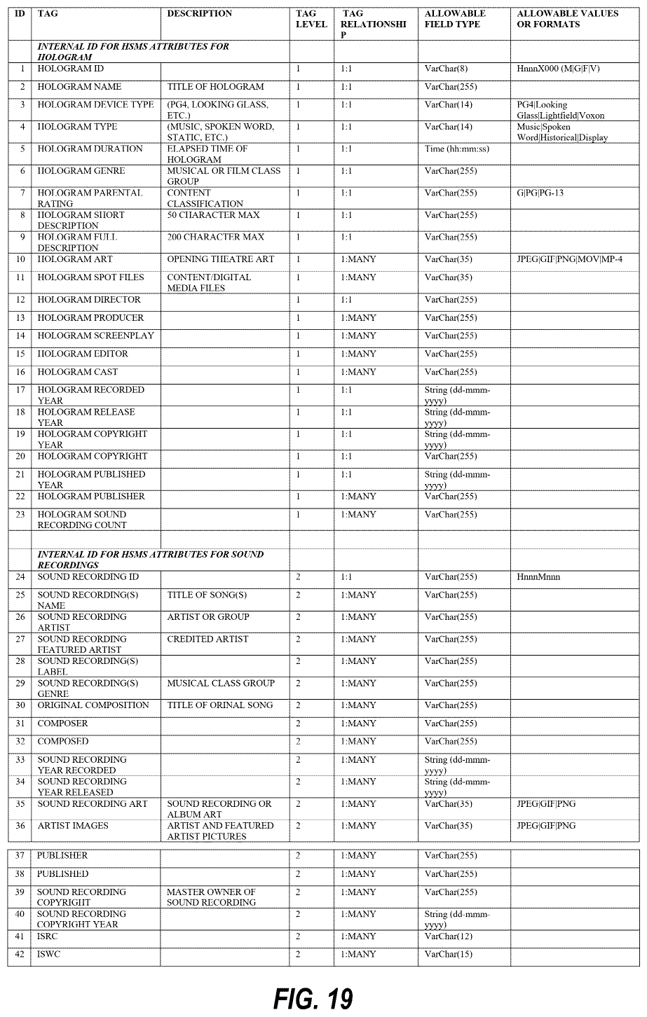

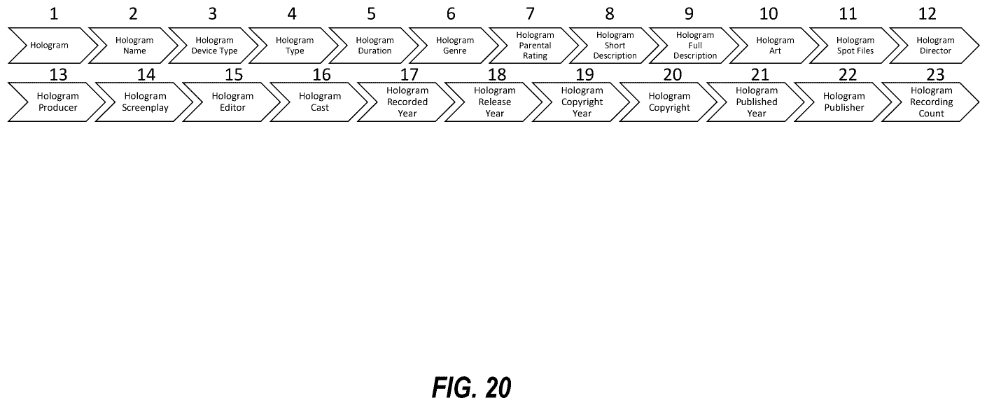

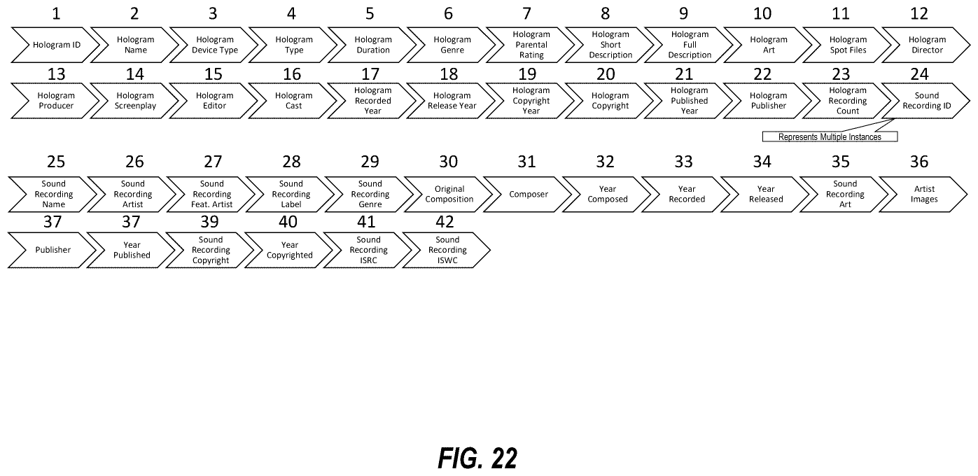

The described technologies (including the referenced holographic streaming platform) can be configured to perform numerous operations, actions, etc. For example, as noted, system 100 can be configured to ingest holograms, e.g., by copying the bytes that make up the media file(s) 146 and adding tags 148 that describe various aspects of the contents of such file(s) (e.g., metadata), as described herein. Further aspects and examples of the referenced metadata process are depicted and described in FIG. 19, FIG. 20, and FIG. 22. In doing so, the described technologies can further enable search of the contents of library/repository 144 (e.g., to identify content associated with specific parameters, as described herein).

Additionally, in certain implementations the described technologies can optimize reliability in a specific venue by automatically downloading a local hologram database, e.g., for the new releases.

As also shown in FIG. 1, server 140 can be configured to communicate with and/or access various external data source(s) 160. Such data sources 160 can be, for example, third-party services that provide various types of media content (e.g., audio content, video content, holographic content, etc.).

In certain implementations, device(s) 110 and/or server 140 can be configured to communicate or otherwise interface with various external services, platforms, networks, etc., such as third-party service(s) 180. Examples of such services or institutions include but are not limited to advertising systems/platforms, ticketing systems, platforms, and/or various other third-party systems, platforms, services, etc., As described herein, the described technologies can be configured to interface with and/or otherwise operate in conjunction with such services 180.

Moreover, in certain implementations, various aspects of the described technologies can be adjusted and/or configured based on inputs or determinations originating from various sensors and/or other devices. For example, in certain implementations, inputs originating from an optical sensor integrated within a content display device 130 can be utilized or accounted for in adjusting aspects of the configuration and/or operation of content management engine 142. For example, based on determination(s) that holographic content is not being displayed property in a given setting, the described technologies can adjust or configure aspects of the described technologies (e.g., to account for such phenomena).

In these and other implementations and scenarios, the described technologies can further configure and/or otherwise interact with various sensor(s) to enhance and/or improve the functioning of one or more machine(s). Doing so can enhance the efficiency, effectiveness, and reliability of the described technologies, as described herein. In contrast, existing technologies are incapable of enabling performance of the described operations in a manner that ensures their efficient execution and management, while also maintaining the security and integrity of such operations, as described herein.

It should be understood that the examples provided herein are intended only for purposes of illustration and any number of other implementations are also contemplated. Additionally, the referenced examples can be combined in any number of ways. In doing so, the described technologies can enhance and/or improve the functioning of one or more machine(s) and/or increase the security of various transactions, as described herein.

While many of the examples described herein are illustrated with respect to multiple machines 110, 140, 160, 180, etc., this is simply for the sake of clarity and brevity. However, it should be understood that the described technologies can also be implemented (in any number of configurations) with respect to a single computing device/service.

Additionally, in certain implementations various aspects of the operations that are described herein with respect to a single machine (e.g., server 140) can be implemented with respect to multiple machines. For example, in certain implementations media repository 144 can be implemented as an independent server, machine, service, etc.

It can be appreciated that the described technologies provide numerous technical advantages and improvements over existing technologies. For example, the described technologies can enable the automated ingestion, presentation, and tracking of holographic media content, as described herein. These and other described features, as implemented with respect to machines 110, 140, 160, 180 and/or one or more particular machine(s), can improve the functioning of such machine(s) and/or otherwise enhance numerous technologies including enabling and enhancing the security, execution, and management of various operations, as described herein.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

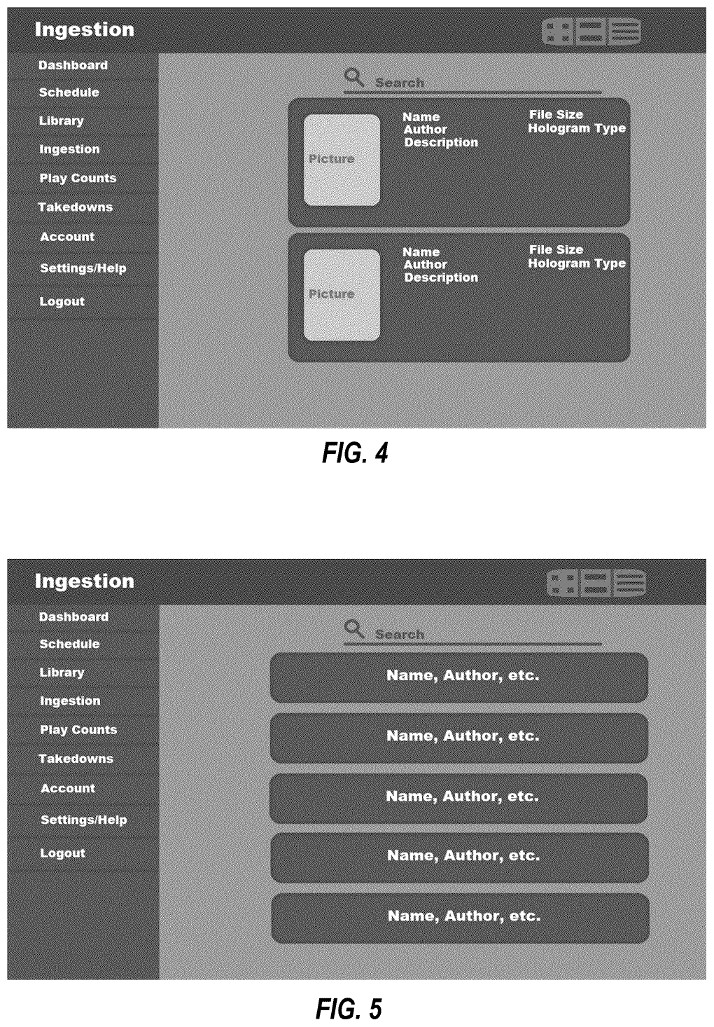

FIGS. 3-5 depict various example graphical user interface(s) (GUIs) that can be presented to a user (e.g., via device 110), through which a user can retrieve and/or select media, e.g., for display or presentation via specific holographic projectors, 130. FIG. 3 depicts an example GUI reflecting a default view of holograms available for download, e.g., from a main server. The full menu appears on the left part of the control console. FIG. 4 depicts an example GUI reflecting the expanded tab view, while FIG. 5 depicts an example GUI reflecting the simplified tab view.

In certain implementations server 100 can further include tracking module 156. Tracking module 156 can be, for example, a software application that can process the contents of log repository 154 and/or can otherwise be configured to enable various royalty inquiries and/or otherwise facilitate rights management (e.g., with respect to intellectual property rights associated with media provided by the system). For example, tracking module 156 can include reporting tools for owners of intellectual property contained in the holographic media 146. Doing so can, for example, enable such owners to claim and/or to otherwise be property paid for the use of music, film, likenesses, brands, or any other intellectual property (IP) (such as may be contained or otherwise incorporated within the referenced media 146 presented by the system).

Examples of the types of rights that tracking module 156 can be configured to manage include but are not limited to: synchronization rights (e.g., the right to use a piece of music as soundtrack with the holograms provided by the system); publishing rights (e.g., the activity of making content available to the public, whereby the publishers must be identified, linked within system, and paid); performance rights (e.g., the right-owners must be identified, linked to the HSMS system, and paid, with such payments being made to performance rights organizations (“PRO”), which can collect royalties on behalf of songwriters and publishers for public performances); video rights (which can correspond, for example, to all rights associated with the production of holograms).

Additionally, in certain implementations tracking module 156 can also be configured to perform various accounting management tasks such as: generating and maintaining audit trails (e.g., playback counts, and data associated with all holograms) and royalty accounting (e.g., collection, processing, and reporting of royalties due to hologram rightsholders).

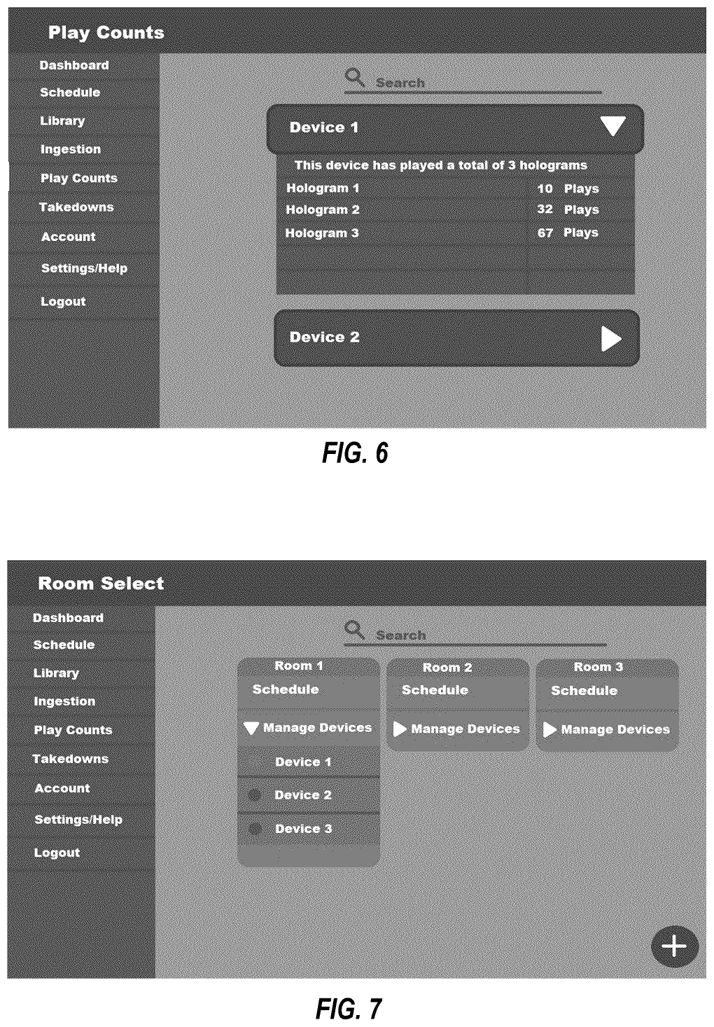

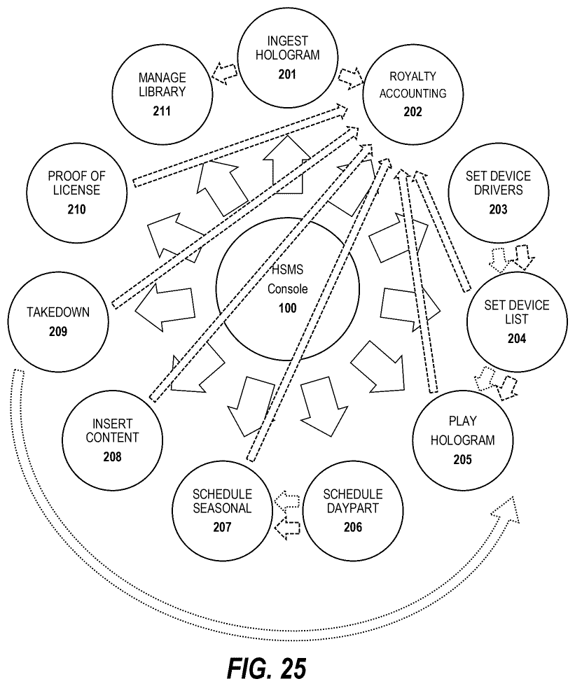

FIG. 6 depicts an example GUI that reflects various operations and features of tracking module 156. As shown in FIG. 6, the referenced module can provide usage statistics, which can be displayed with respect to individual devices 130. Further aspects of these operations and features are depicted with respect to FIG. 25 (with respect to royalty accounting operations 202, as described herein, and the relationship between such operations and others described herein).

As also described herein, system 100 and/or tracking module 156 can be configured to automatically track intellectual property rights and licenses, such as those associated with media 146. This automatic identification process can ensure that rights holders can be paid according to current contracts and that partners receive reliable and verifiable reports reflecting the actual usage of corresponding content.

In certain implementations, system 100 and/or tracking module 156 can be configured to generate and/or otherwise provide reports include metadata 148, such as various tag IDs, such as those as shown in FIG. 19. In certain implementations, the contents of the referenced report(s) can further include data gathered from various transactions, such as those described herein (e.g., with respect to FIG. 25).

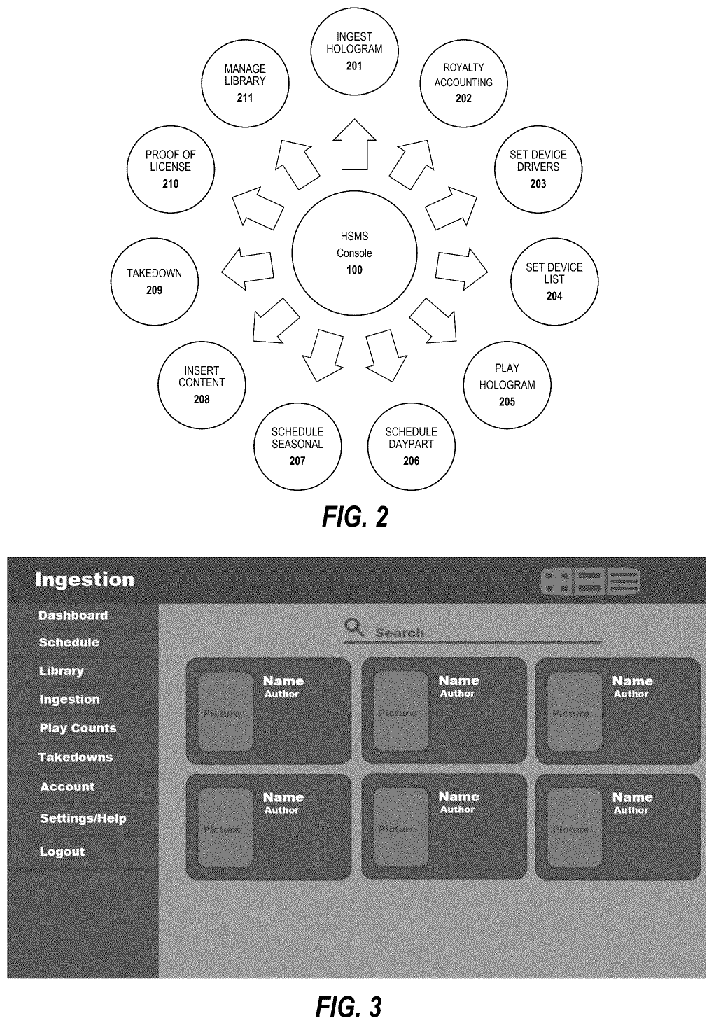

FIG. 2 depicts further aspects of various operations of system 100. Such operations can include various processes involved in automatic identification. Examples of such processes include: Origin identification (ID); Categories ID; Right Holders ID; Creators ID; Performers ID; and Antitheft ID.

System 100 can implement the referenced origin identification by applying a combination of acoustic analysis, recognition, and metadata processing to media content 146 and its associated metadata 148. When combined, this process can produce a unique identifier (e.g., a 255-character identifier) that can certify the origin of the hologram and its elements (e.g., text, images, videos, sound recordings, etc.). In doing so, system 100 can confirm the uniqueness of the hologram and ensure it can instantly retrieve the information that refers to it (e.g., the various tags as depicted in FIG. 19 and described herein). For example, apart from tag IDs 1 and 24 (as shown in FIG. 19), the referenced metadata can be communicated by the rights holders (as opposed to being generated by the system 100) but collected and/or imported in conjunction with the referenced operation(s).

As also reflected in FIG. 2 and described herein, system 100 can implement the referenced categories identification operations. In certain implementations, such categories can be generated by system 100 automatically from the metadata imported in prior operations and/or manually. The referenced categories can originate from metadata tags 148 (such as those depicted in FIG. 19 and described herein).

As also reflected in FIG. 2 and described herein, system 100 can implement operations relating to the identification of the right holders and owners, which can be determined, for example, based on metadata tags 148 (such as those depicted in FIG. 19 and described herein). Additionally, in certain implementations the contents of such tags 148 can be combined with the acoustic recognition operations (e.g., performed with respect to the ingest hologram operations, as described herein).

As also reflected in FIG. 2 and described herein, system 100 can implement operations relating to hologram count statistics, such as when combined with the above Tag IDs. Doing so can produce reports used in various transactions described herein.

As also reflected in FIG. 2 and described herein, system 100 can implement operations relating to the identification of creators (e.g., composers, lyricists, arrangers, and others), which can be performed in a comparable manner to other processes described herein.

As also reflected in FIG. 2 and described herein, system 100 can implement operations relating to the identification of performers (artists, directors, editors, and others) which can be performed in a comparable manner to other processes described herein.

As also reflected in FIG. 2 and described herein, system 100 can implement operations relating to anti-theft identification. Such operation(s) can include writing the unique identifier of the hologram (origin ID, generated in the manner described above) into system 100 and storing an acoustic fingerprint (e.g., as captured in in the manner described above) in the HSMS. Such a unique identifier can then be inserted, integrated, or otherwise injected into the hologram. Doing so can ensure that it is deeply embedded in the digital signal and/or ensure that it is replicated periodically (e.g., every second), so that it is difficult (if not impossible) to remove it. System 100 can utilize various watermarking techniques to perform the referenced operations.

As described herein, the described technologies can implement a unique process that includes the combination of watermarking and acoustic recognition, both of which can identify a hologram that is stolen and/or used without permission. Even if the unique identifier were to be completely extracted hundreds of times from a stolen hologram, it would still be recognized when it was first publicly released. To do this, various rights holders and partners can access system 100, which can allow them to read any hologram and compare it with the acoustic fingerprints of the media files 146 stored in repository 144. Doing so can further enable a determination concerning whether the hologram played is authentic/authorized (or if it has been stolen or altered from the original version). An intranet site provided by system 100 can also enable the detection of the anti-theft ID even if only one second of the original hologram has been copied into a new one.

As shown in FIG. 2, in certain implementations the described technologies (e.g., system 100) can be further configured to set device drivers (203). For example, system 100 can be configured to ensure that a hologram 146 will only be presented via content display devices 130 or on stages (or other such presentation settings) capable of rendering the three-dimensional image realistically, and to the extent supported by the specific media or hardware and formats that will render holograms differently for each individual display on a specific device. Further aspects of the referenced operation(s) are depicted in FIG. 7 (showing an example GUI reflecting that certain holograms can be presented via certain content display devices but not others). As also shown in FIG. 2, in certain implementations the described technologies (e.g., system 100) can be further configured to set emitter/stage/device list (204). For example, system 100 can include a repository or list of holographic content display devices 130 and/or cinema stages, such as those arranged in a venue, campus, or network (which can include, for example, the device type, and device name). This device repository/list can be used to ensure that holographic media are only played on stages or devices upon which they are technically compatible and technically suitable.

By way of illustration, an example of such a suitability check would be to ensure that a hologram of a jazz singer from 1920 does not appear on a stage for a punk rock bar. System 100 can, for example, match the holographic media 146 (in addition to its associated metadata 148) to the stage, device, etc. upon which it will play. These operation(s) allow holographic devices 130 to be added, edited, inquired about, and deleted. Accordingly, in certain implementations system can be operably connected to a separate sensor system (e.g., optical sensors integrated within device(s) 130 and/or in proximity to them) that can assess or otherwise determine aspects of the viability of quality of an intended location where a hologram or plurality of holograms are played and can provided sensed feedback to the HSMS to alter the range of parameters under which the hologram is played.

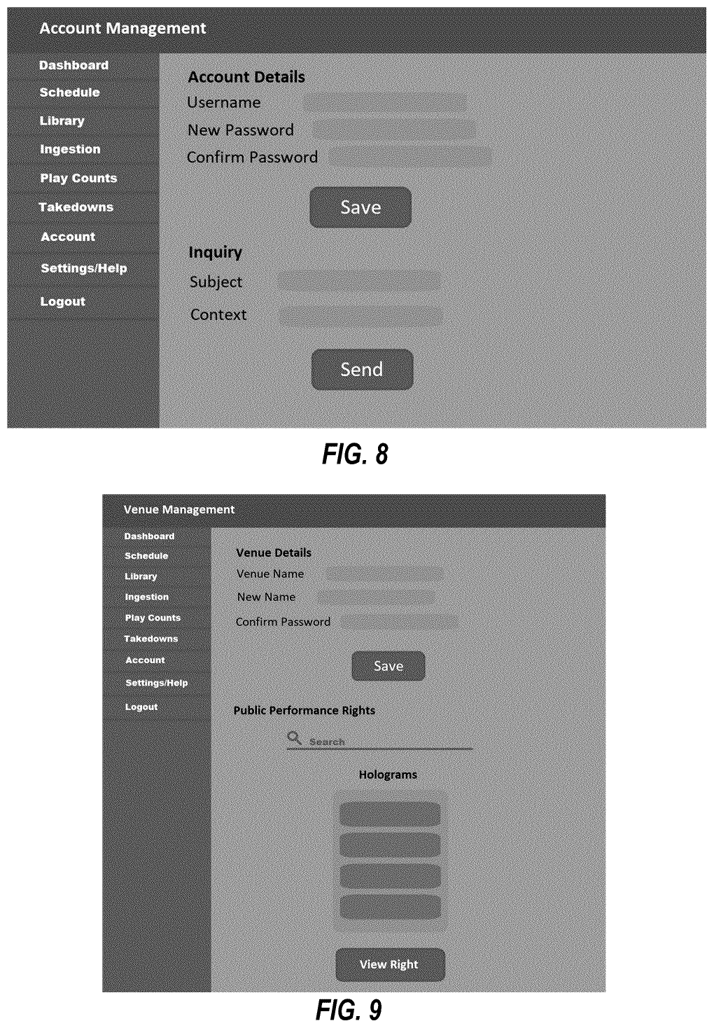

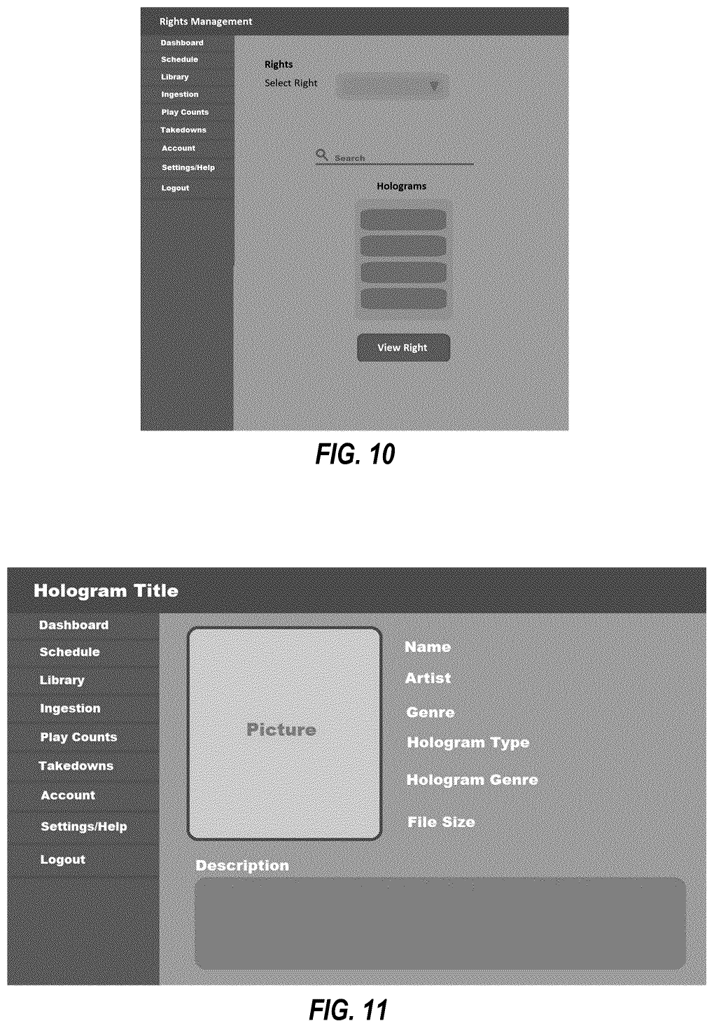

Further aspects of the referenced operation(s) are depicted in FIGS. 8-10. For example, FIG. 8 depicts an example GUI of an account management view of the described technologies. FIG. 9 depicts an example GUI of a venue management view. FIG. 10 depicts an example GUI of a rights management view.

As also shown in FIG. 2, in certain implementations the described technologies (e.g., system 100) can be further configured to transmit, play, or otherwise present a hologram (205). System 100 be configured, for example, to automatically transmit or play the holographic media files 146 (e.g., those stored in media repository 144), such as via content display devices 130. It should be understood that although viewers can see the referenced holograms with the naked eye, the described technologies can also be configured to support other types and formats of holograms such as: Lightfield, Peppers Ghost, Looking Glass, Transmission, Hybrid, etc.

Further aspects of the referenced operation(s) are depicted in FIG. 11 (showing a GUI with the specified hologram view with accompanying metadata details). This view is also accessible through operations 201 (ingestion), 211 (library), or 204 (set emitter/stage/device list management), as depicted in FIG. 2 and described herein. It should also be noted that FIG. 25 illustrates further aspects of the relationship between these operations and others enabled by system 100, as described herein.

As also shown in FIG. 2, in certain implementations the described technologies (e.g., system 100) can be further configured to schedule daypart (206). In various venues that are equipped with holographic content display devices 130 (such as a campus, theme park, or other locations) the described technologies can schedule the playing of specific holograms in specific pre-selected time windows or in time windows that meet various defined conditions. For example, in a music theme park, the described technologies can configure or set device(s) 130 to project or otherwise perform children's songs in the morning, whereas music associated with a different target audience, such as with mature themes, can be set to play only in evening hours. As noted, tracking module 156 can be configured to maintain the actual counts of the projected holograms, e.g., for legal and financial processing.

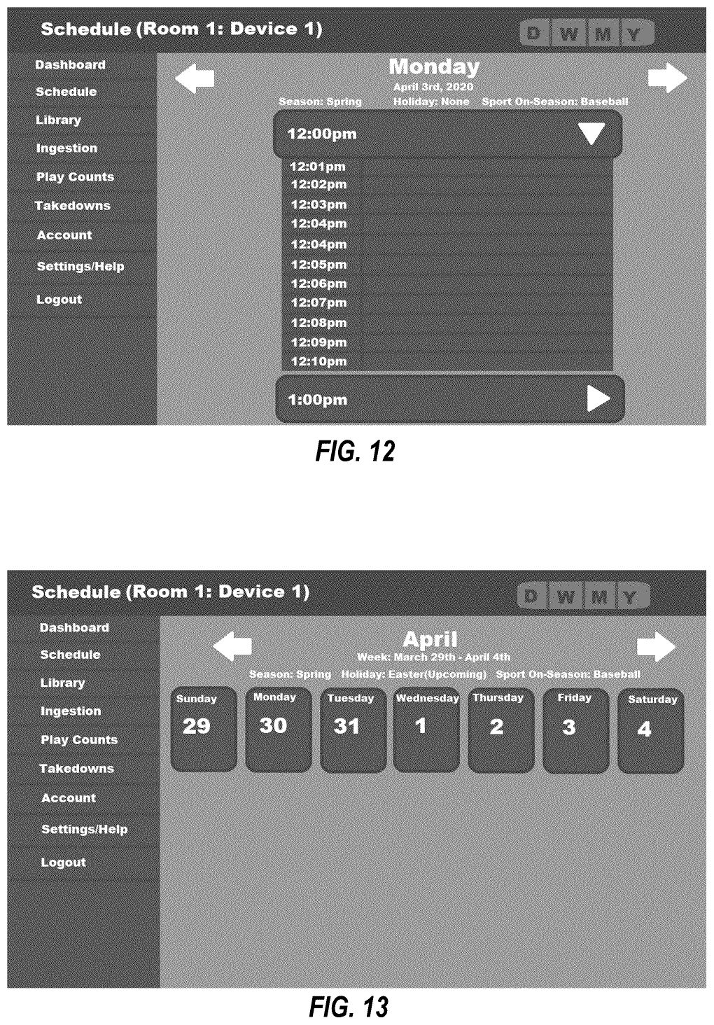

Further aspects of the referenced operation(s) are depicted in FIG. 12 (showing a GUI reflecting the rooms and devices interface where hours can be set for every room and device). FIG. 13 depicts a GUI reflecting the rooms and devices interface (where days can be set for every room and device.

As also shown in FIG. 2, in certain implementations the described technologies (e.g., system 100) can be further configured to schedule seasonal content (207). For example, certain holograms can be scheduled to play only at certain times of year, or days of the week. Some holograms are associated with certain holiday seasons. Holiday themed holograms are scheduled to appear only in the weeks leading up to Christmas or the New Year. Scary holograms could be scheduled only in the leadup to Halloween. Some holograms of religious or cultural significance might be set only to appear on Sunday mornings. Holograms can also be programmed to display during specific events; for example, during different awards seasons, holograms which include media nominated for film or music awards are featured in a context dependent playlist and be selected or de-selected based on input value to system 100 that can rotate a hologram into or out of a rotation based on user input. As noted, tracking module 156 can be configured to maintain the actual counts of the projected holograms, e.g., for legal and financial processing.

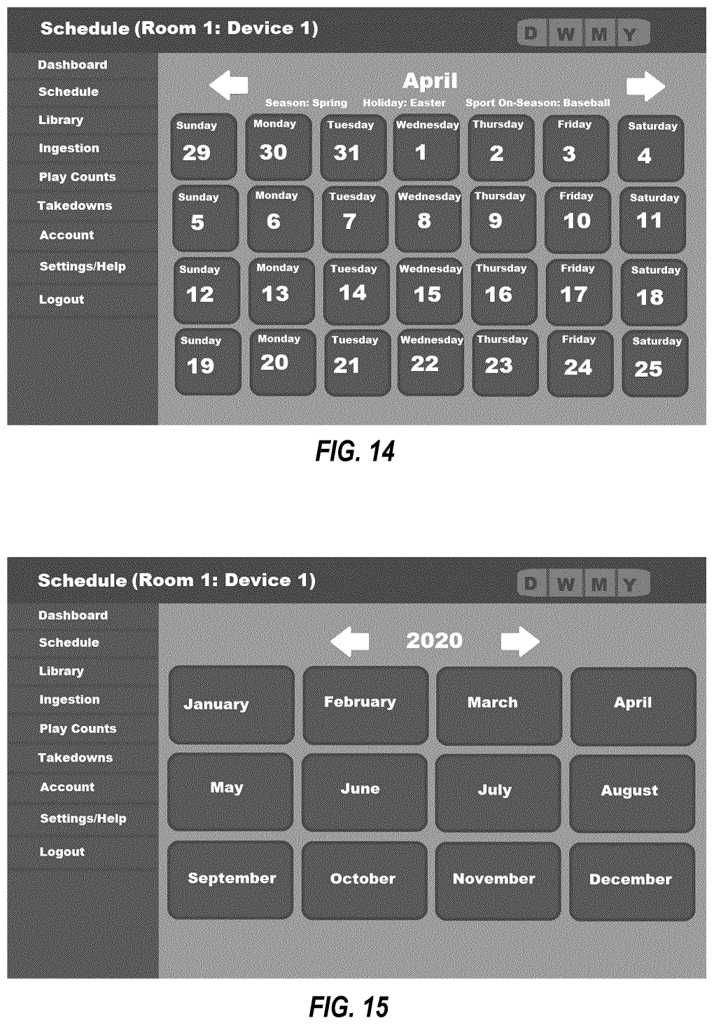

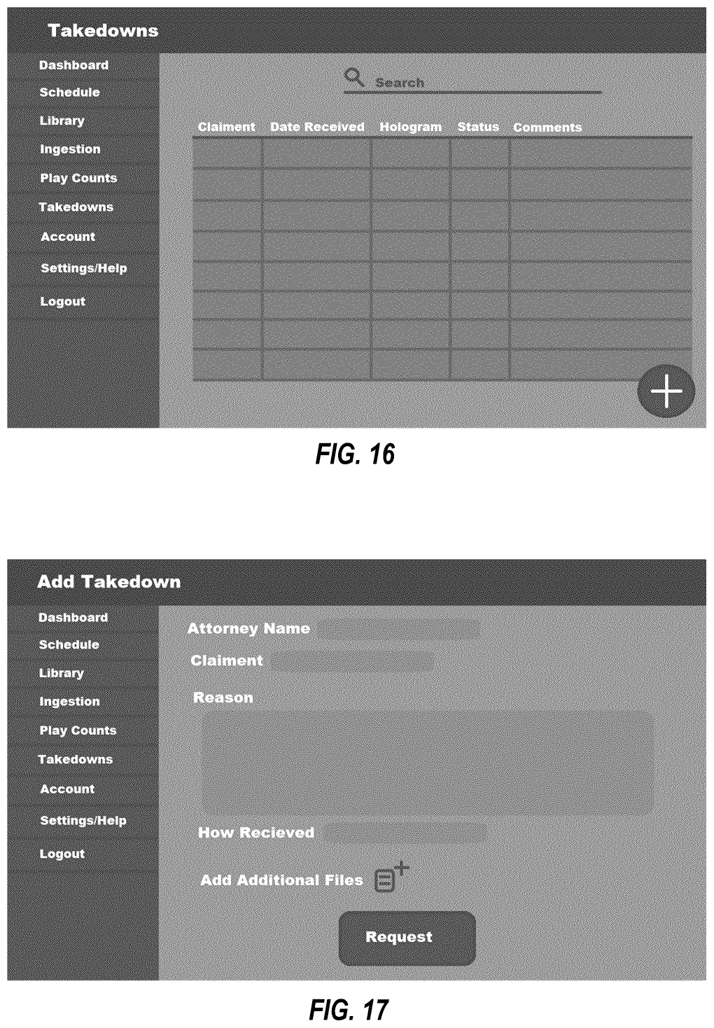

Further aspects of the referenced operation(s) are depicted in FIG. 14 (a GUI showing the rooms and devices interface where months can be set for various rooms and devices). FIG. 15 depicts a GUI showing the rooms and devices interface where years can be set, e.g., for every room and device.

As shown in FIG. 2, in certain implementations the described technologies (e.g., system 100) can be further configured to insert content (e.g., commercials or other such sponsored content) within hologram presentations (208). For example, certain holograms, media, etc. 146 can be financed and presented with advertising. These advertisements can take the form of words or logos that appear within the holographic entertainment itself, such as a spirits or soft drink logo that appears on the wall behind a singer. Alternatively, in certain implementations such sponsored content can be a holographic pre-roll, mid-roll, or post-roll commercial. System 100 can be configured, for example, to dynamically integrate selected advertising or promotional content into separate hologram media files thereby merging or integrating one distinct set of content in a first media with a separate, second media file having discrete content. The HSMS thereby allows merger of multiple data files at the discretion of the user operator and selected files can be included or deleted (e.g., at the discretion of a system user/administrator).

As also shown in FIG. 2, in certain implementations the described technologies (e.g., system 100) can be further configured to initiate various takedown operation(s) (209). Media companies occasionally receive demands to remove certain media or subsets of media from use in a venue or presentation system. Administrators, managers, and/or users of system 100 can be presented or otherwise be provided with claims of infringement (corresponding, for example, media being presented without authorization by the rights owner). In ensure uninterrupted functionality, system 100 can enable various takedown operation(s), e.g., with respect to specific hologram(s) or portion(s) of data file enabling the removal of selected content from the scheduling playlist temporarily and optionally generating a replacement image, content or data file. Such operations can also include alerts (e.g., to an appropriate legal resolution team) to further investigate the takedown. System 100 can also provide a transaction to update the status of the takedown, such as to clear the hologram for return to use, make the takedown permanent, or mark its status as under further review.

Further aspects of the referenced operation(s) are depicted in FIG. 16 (a GUI showing the search view where status indicates the received, pending, removed and restored holograms). FIG. 17 depicts a GUI showing the ‘add’ view.

As also shown in FIG. 2, in certain implementations the described technologies (e.g., system 100) can be further configured to initiate various show proof of license operation(s) (210). For example, as described herein, metadata 148 can include the actual contracts (e.g., electronic copies of documents or smart contracts), which demonstrate the authorized use of intellectual property (e.g., images, audio, video, etc.) embedded in the hologram. These include licenses for music, videos, artist likeness, synchronization, logos, or any other such IP.

As also shown in FIG. 2, in certain implementations the described technologies (e.g., system 100) can be further configured to manage a content library (211). For example, system 100 can facilitate transactions or operations through which the library 144 of available holograms 146 that are eligible or otherwise available for streaming to the devices 130 or are otherwise network supported (e.g., by this HSMS instance). Such operations include ingest (e.g., add) new hologram, change hologram (e.g., by editing its associated metadata), delete a hologram, and inquire about the hologram, such as any of its metadata fields.

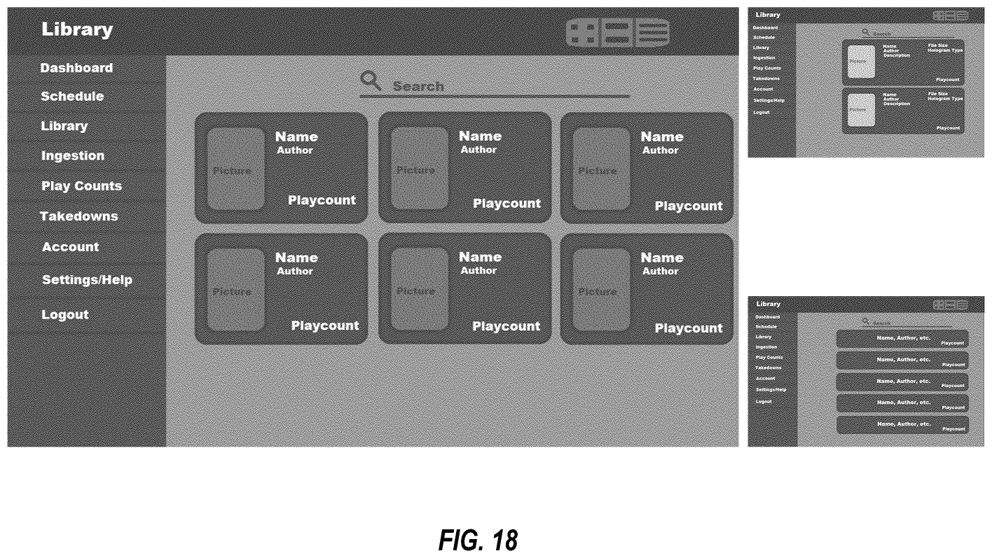

Further aspects of the referenced operation(s) are depicted in FIG. 18 (GUIs showing multiple views of the console where uploaded holograms can be searched and processed in the manner described herein).

As shown in FIG. 1 and described herein, system 100 can include or otherwise incorporate various communication interfaces that allow it to exchange data with external systems or services 180. Examples of such services include ticketing system (through which royalty and metadata can be processed with respect to and/or otherwise combined with ticketing information), advertising systems (through which data relating to internal advertising, sales and marketing, and exterior billboards, can be exchanged), and the various third parties involved in operations including ingest hologram (201) royalty accounting inquiry (202) insert content/commercial (208), takedown (209), and show proof of license (210), as described herein.

As noted, in addition to the sound and three-dimensional (3D) video recordings, the referenced holographic media files 146 can also contain and/or otherwise be associated with tags 148 (e.g., metadata tags). Certain metadata tags 148 can originate from tags previously used for audio or two-dimensional video while other tags are new and only applicable to holograms. In certain implementations, system 100 can apply these tags during ingestion into the content library/repository 144. Alternatively, in certain implementations such tags can be edited and/or added by system 100/content management engine 142 (e.g., after the corresponding content is already stored in library 144).

During a stream of a hologram 146, its associated tags 148 are read or otherwise processed. Doing so can enable system 100 and/or content management engine 142 to determine to render the hologram. For example, tags 148 can instruct system 100 and/or content management engine 142 when to stream it, which emitters/content presentation devices 130 to use (or not to use), and which holographic cinema stage to stream it to. As the hologram is presented, system 100 can generate and/or maintain audit trails (as stored in log repository 154), for subsequent processing by royalty accounting and/or by management information systems.

It should be noted that certain metadata fields can be used more than once. For example, if there are multiple sound recordings or musical compositions within a hologram, such a hologram can include multiple sets of tags for all fields related to the sound recording or composition, and the tag will have a notation of 2, 3 . . . up to n, where n is the total number that are embedded in the media file.

Examples of the referenced metadata tags 148 include: hologram name (e.g., an identifier of the hologram; hologram title (e.g., a text name of the hologram); hologram duration (e.g., an elapsed time); song title (e.g., a title of song(s)/composition(s) in media file); artist name (e.g., name(s) of artist(s) in media file); hologram genre (e.g., a general genre of media file); hologram type (e.g., Music, Spoken Word, Speech, Play); hologram category (e.g., Entertainment, Commercial, Scientific); hologram genre (e.g., the general genre of media file); hologram parental rating (e.g., G, PG, PG-13, etc.); hologram short description; hologram full description; hologram art (e.g., opening theater art); hologram device (e.g., a device type of media file through which the hologram must be rendered); hologram release year (e.g., a media file release year); hologram copyright (e.g., a media file year, copyright owner, and other copyright information); hologram publishing (e.g., a media file year and publisher); hologram spot file (e.g., a digital media file identifiers and type (e.g., billboards, etc.)); eligibility date (e.g., the date after which the hologram is eligible to be played); expiration date (e.g., a date after which this hologram can no longer be played); hologram recording count; sound recording title (e.g., a song title); sound recording artist (e.g., a song artist+IPI); sound recording label (e.g., the original label(s) of the song); sound recording genre (e.g., a Song Genre); sound recording (e.g., a song release year); sound recording copyright (e.g., a song year and copyright owner+IPI); sound recording ISRC code (e.g., a Master Recording Unique Identifier); sound recording publishing (e.g., a song year and publisher+IPI); sound recording composer (e.g., a song writer+IPI); sound recording image (e.g., an artist image files); sound recording ISWC (e.g., a composition's unique identifier); sound recording license; hologram license file (e.g., an electronic copy of the license to the Hologram or smart contract); year composed (e.g., song composed year); year recorded (e.g., song recorded year); year released (e.g., song released year); sound recording art (e.g., image file(s) related to the recording or the album); artist image (e.g., artist(s) image files); publisher (e.g., publisher(s)+IPI, and other publishing information); year published (e.g., song published year); sound recording copyright (e.g., copyright owner(s)+IPI, and other copyright information); artist likeness license (e.g., an electronic copy of license or smart contract); logo or image license (e.g., an electronic copy of license or smart contract). It should be understood that the referenced metadata fields are provided by way of illustration and that the described technologies can be configured to operate with respect to any number of other such fields. For example, additional metadata fields can be added for various other production credits.

It should be understood that the referenced Interested Party Information (“IPI”) can be a unique, identification number (e.g., 9-11 digits long). IPIs can be assigned to actors, songwriters, composers and music publishers, or any other noteworthy persons whose music appears in the holograms or who appear in the hologram.

The referenced metadata fields 148A, 148B, etc. can also be edited, as described herein. Additionally, an audit trail can be maintained, reflecting changes to any of the above or other selected parameter(s). This process can be managed in the library (e.g., at operation 211 as described with respect to FIG. 2). As noted, FIG. 18 depicts various GUIs of the console where holograms can be searched for, and metadata can be edited.

Further aspects of the referenced metadata and its formats are shown in FIGS. 19 and 22. The numbers before the field names can refer to the tag IDs in FIG. 19, FIG. 20, and FIG. 22. Additional metadata fields can be added, e.g., for production credits, etc.

FIG. 19 is an example classification of certain metadata 148 that can be used in system 100, as described herein. The referenced metadata can, for example, describe attributes for hologram and sound recordings. The list includes: “Tags” (the fields used in the system), “Descriptions” (a short explanation about the usage or the function of the Tags), “Tag Levels” (where the value “1” qualifies the Tags used for the Holograms and the value “2” qualifies the Tags used for the Sound Recordings), “Tag Relationships” (where “1:1” qualifies a relationship which proposes only one value for one specific Tag and where “1:MANY” qualifies a relationship which proposes one or more values for one specific Tag), “Allowable Field Types” (where Time values are formatted as HH:MM:SS, Date values as DD-MMM-YYYY, and Text values limited to XXX characters, where XXX can be 5, 8, 14, 30, 35 or 255), “Allowable Values or Formats” (where allowable values are separated by a vertical bar or pipe—Unicode: U+007C).

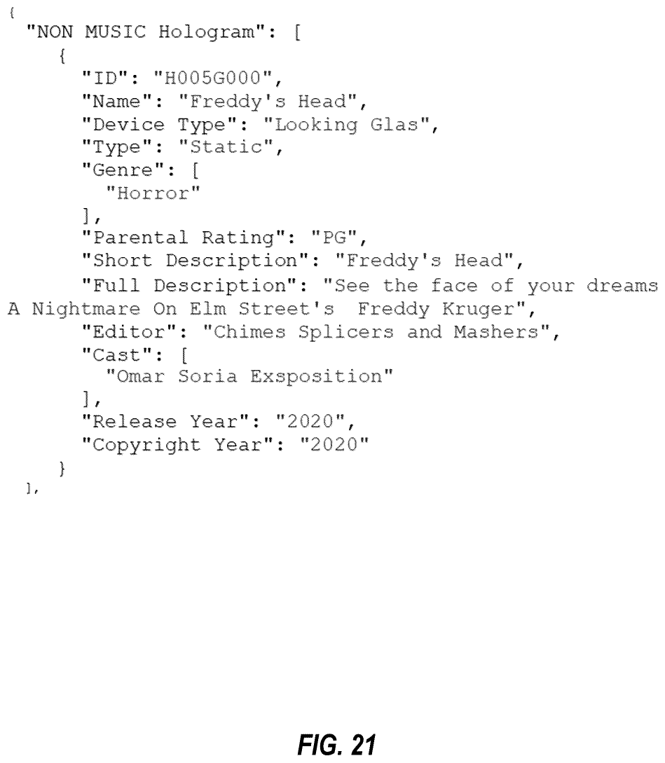

FIG. 20 depicts an example process by which such metadata information can be provided for the non-music schema. The referenced data input process can pertain to hologram content. Such input can start, for example, with the Hologram Identifier (tag 1, as shown in FIG. 20) and proceed through other such tags, as shown. FIG. 21 depicts an example of such processed data, after validation (depicting the tag names—e.g., “ID,” “Name,” etc., and the values, e.g., “H00 . . . ,” “Freddy's . . . ,” etc.). In certain implementations, such content can be stored and/or exported in JSON (JavaScript Object Notation) format.

FIG. 22 depicts an example process by which such metadata information can be provided for the music schema. This example input process can be applied for both the hologram and the sound recording. Such an input can start with the Hologram Identifier (tag 1, as shown in FIG. 22) and proceed through other such tags, such as Sound Recording ISWC (tag 42, as shown in FIG. 22). The referenced ISWC (International Standard Musical Work Code) can be a unique reference number, e.g., for the identification of musical works.

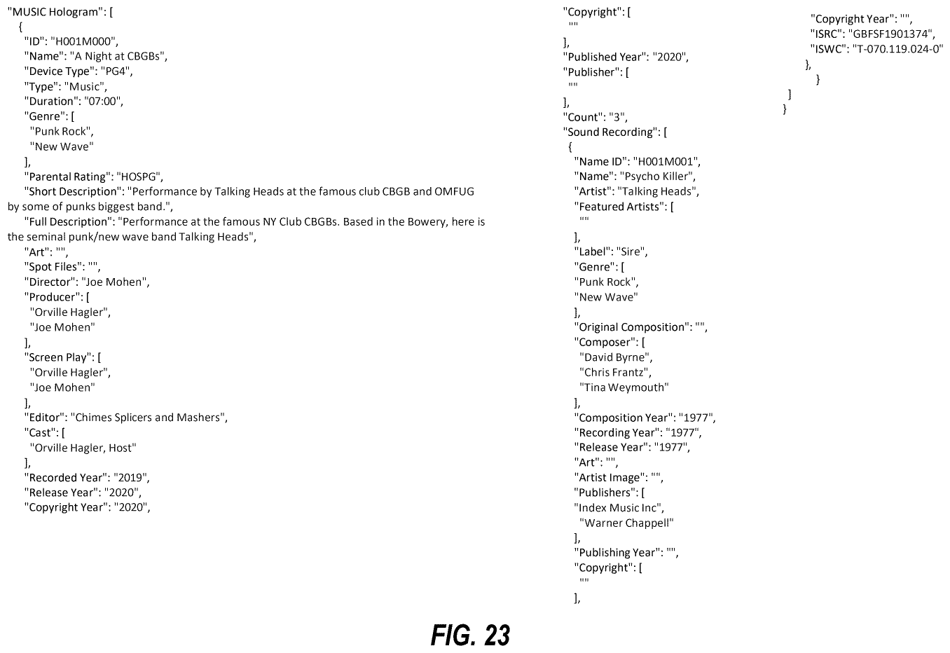

FIG. 23 depicts an example of such processed data (e.g., of a single sound recording), after validation (depicting the tag names—e.g., “ID,” “Name,” etc., and the values, e.g., “H00 . . . ,” “A Night . . . ,” etc.). The format used for the export is JSON. FIG. 23 depicts an example of such processed data, after validation, corresponding to multiple sound recordings.

As noted, an audit trail is kept of all the holograms 146 played (e.g., via devices 130), including play counts, first play and last play. A separate audit trail can also be maintained for master recordings and musical compositions and can be tied to any applicable digital rights such as a report for review by royalty accountants. These could be inspectable online or through reports created for review by royalty accountants.

As noted, in certain implementations the described technologies can be configured to interface with various third-party systems, services, etc. 180. For example, venues and campuses at which system 100 delivers hologram content via devices 130 can use system 100 as integrated with a separate or linked ticketing system (e.g., that issues admissions tickets). System 100 can be configured to interface with such third-party services 180, e.g., to produce reports and support inquiries to determine which holograms are associated with higher or lower ticket sales, and any other data which might be desired by management information systems.

By way of further illustration and as shown in FIG. 1, in certain implementations the described technologies can be configured to interface with various third-party advertising systems, services, etc. 180. For example, as described herein, system 100 can enable the timed selection of content, such as advertisements before, during, or after a separate, selected hologram is played. This content can be selectively timed to occur at a pre-determined point in time relative to the selected hologram such as on the cinema stage just before the hologram plays, just like a pre-roll stream appears before conventional 2D videos online. However, such a holographic pre-roll accompanies content such as actors in the commercials appear in the venue to be viewed by an audience. Such content is scheduled in front of an entertainment or scientific hologram and can also be scheduled with corresponding scheduling criteria.

In certain implementations, system 100 can be configured to present sponsored content (e.g., advertisements) before, during, or after a hologram played or otherwise presented. Such sponsored content can be, for example, a short commercial appearing on the cinema stage just before the hologram plays.

The advertising campaign can include beginning and ending dates which can be set to match or mirror the beginning and ending dates of the hologram that are set through metadata 148. Other metadata fields can be available for the commercial (unless, for example, the licenses supersede these). Accordingly, a core hologram 146 can be associated with supplemental content in a second hologram that is linked to the core hologram as to timing, location, duration, or any other parameter described herein.

In certain implementations, system 100 can also be configured to enable product placements, e.g., within a hologram 146. Such product placement can be fixed such that an actor or performing artist wearing an article of clothing from a sponsor, or together with a tangible article with a sponsor logo appearing prominently. The referenced product placement can be dynamic such that system 100 can interface, for example, with mixed reality software that provides for dynamic insertion of a logo or other placed product such as a bottle of spirits.

System 100 can also be configured with respect to separate display devices that can present other content that corresponds to the content of the hologram data files. For example, holographic venues (e.g., entertainment venues) can feature large programmable electronic signs/billboards, e.g., outside the venue entrances. System 100 can be configured to transmit content to such displays about which holograms or artists are being featured in holographic performances (e.g., that day or in the future). System 100 can interface with such a billboard system 180 such that information about a hologram is displayed via the billboard(s) (e.g., a daily playlist, ticketing information such as the next available ticket time, etc.).

System 100 can also be configured to generate reports about the operations and performance of a holographic attraction or campus. Doing so can, for example, enable administrators, managers etc. to assess its performance and plan changes of use, if any.

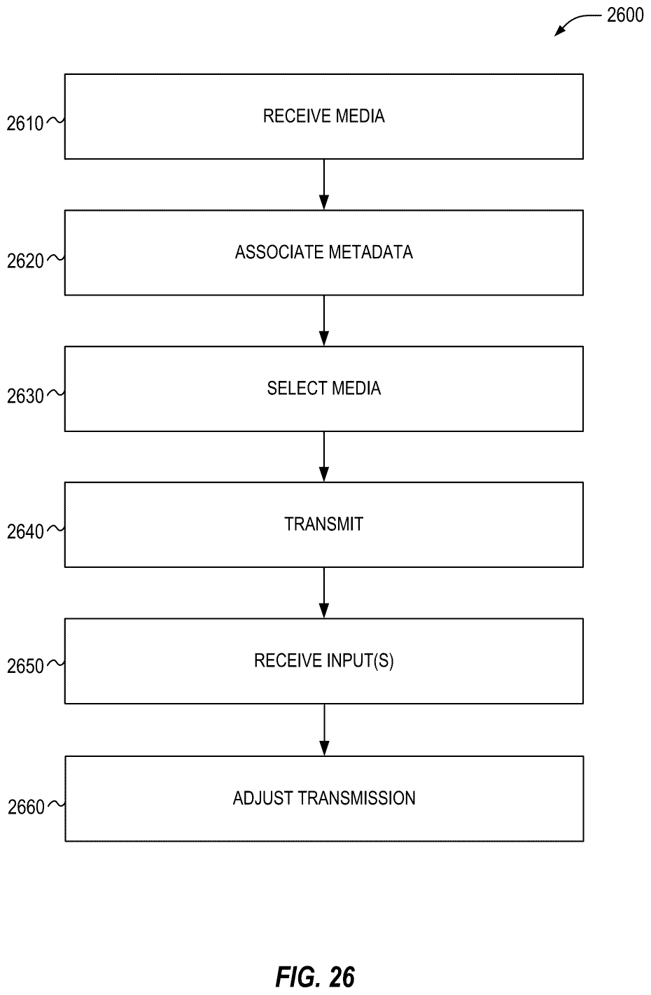

FIG. 26 depicts a flow chart illustrating a method 2600, according to example embodiments, for holographic streaming management. Further aspects of the described technologies include methods performed by processing logic that can comprise hardware (circuitry, dedicated logic, etc.), software (such as is run on a computing device such as those described herein), or a combination of both. In one implementation, such method(s) are performed by one or more elements depicted and/or described in relation to FIG. 1 (including but not limited to server 140, content management engine 142, or device(s) 110), while in some other implementations, the described operations can be performed by another machine or machines.

For simplicity of explanation, methods are described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the disclosed methods are capable of being stored on an article of manufacture to facilitate transporting and transferring such methods to computing devices. The term article of manufacture, as used herein, is intended to encompass a computer program accessible from any computer-readable device or storage media.

At operation 2610, a first media content item is received (e.g., by server 140 and/or content management engine 142), such as in a manner described herein. For example, as shown in FIG. 1 and described in detail herein, server 140 can receive media content items (e.g., hologram files, etc.) 146A, 146B, etc.

At operation 2620, one or more metadata tags are associated with the first media content item (e.g., the media content item received at operation 2610) (e.g., by server 140 and/or content management engine 142), such as in a manner described herein. For example, as depicted in FIG. 1 and described in detail herein, metadata tags 148A, 148B, etc., can be associated with media content item 146A.

Moreover, in certain implementations one or more acoustic recognition techniques and/or digital watermarking techniques can be applied to the first media content item, as described herein. Additionally, in certain implementations the referenced metadata tags 148 can be edited (e.g., in relation to previously associated values).

At operation 2630, the first media content item (e.g., as received at operation 2610) is selected (e.g., by server 140 and/or content management engine 142) for presentation, e.g., at a first holographic presentation device 130, such as in a manner described herein. In certain implementations, the referenced media content item 146 (e.g., a hologram) can be selected for presentation based on at least one of the one or more metadata tags to which it is associated, as described herein.

Additionally, in certain implementations the first media content item can be selected for presentation at a first holographic presentation device 130 based on one or more aspects of such a holographic presentation device (e.g., the setting in which it is deployed or arranged, other aspects or features of the device, etc.), as described herein.

At operation 2640, the selected first media content item (e.g., as selected at operation 2630) and a content presentation file 152 associated with the first holographic presentation device are transmitted to the first holographic presentation device 130 (e.g., by server 140 and/or content management engine 142), such as in a manner described herein. Such a content presentation file can include, for example, a driver, code, or other such instructions 152 associated with the first holographic presentation device 130. Additionally, in certain implementations the selected first media content item can be transmitted together with a third media content item (e.g., a sponsored media content items, such as a commercial or other such sponsored content) as injected into the first media content item in a manner described herein, to the first holographic presentation device 130.

At operation 2650, one or more inputs corresponding to a presentation of the first media content item via the first holographic presentation device are received (e.g., by server 140 and/or content management engine 142), such as in a manner described herein. In certain implementations, inputs originating from a sensor (e.g., an optical sensor) positioned proximate to the presentation of the first media content item via the first holographic presentation device (and/or originating from the first holographic presentation device) can be received. Such inputs can be processed, e.g., to determine one or more capabilities of the first holographic presentation device, as described herein.

At operation 2660, one or more aspects of a transmission of a second media content item to the first holographic presentation device can be adjusted (e.g., by server 140 and/or content management engine 142), such as in a manner described herein. In certain implementations, such aspects can be adjusted based on the received one or more inputs. Additionally, in certain implementations the received one or more inputs can be processed to determine one or more aspects of the presentation of the first media content item via the first holographic presentation device, as described in detail herein.

It should be understood that the examples provided herein are intended only for purposes of illustration and any number of other implementations are also contemplated. Additionally, the referenced examples and implementations can be combined in any number of ways.

It should also be noted that while the technologies described herein are illustrated primarily with respect to holographic streaming management system, these technologies can also be implemented in any number of additional or alternative settings or contexts and towards any number of additional objectives.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

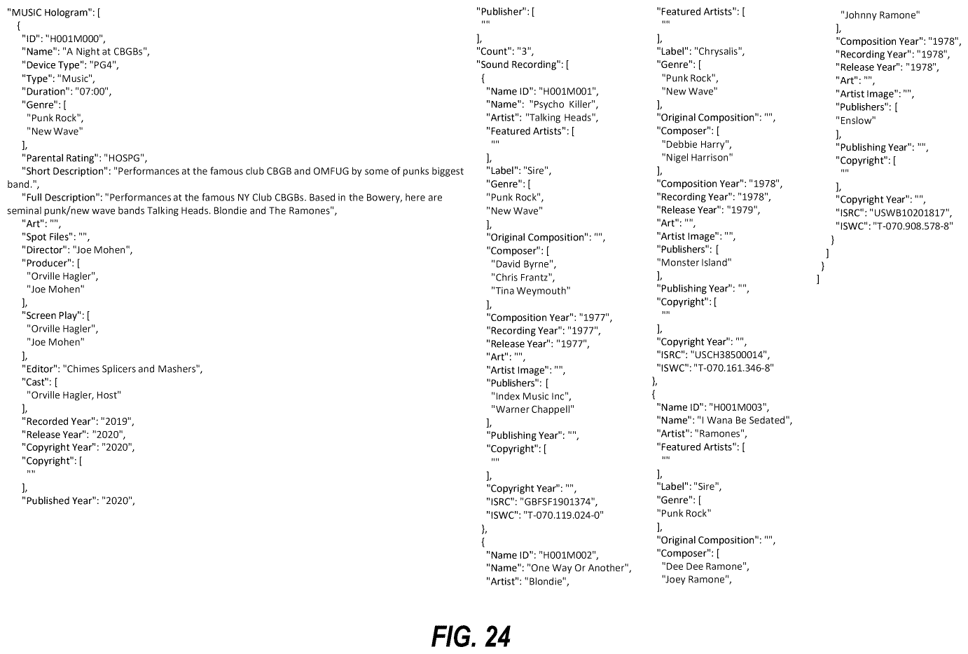

The modules, methods, applications, and so forth described in conjunction with FIGS. 1-26 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 27 is a block diagram illustrating components of a machine 2700, according to some example implementations, able to read instructions from a machine-readable medium (e.g., a machine-readable storage medium) and perform any one or more of the methodologies discussed herein. Specifically, FIG. 27 shows a diagrammatic representation of the machine 2700 in the example form of a computer system, within which instructions 2716 (e.g., software, a program, an application, an applet, an app, or other executable code) for causing the machine 2700 to perform any one or more of the methodologies discussed herein can be executed. The instructions 2716 transform the non-programmed machine into a particular machine programmed to carry out the described and illustrated functions in the manner described. In alternative implementations, the machine 2700 operates as a standalone device or can be coupled (e.g., networked) to other machines. In a networked deployment, the machine 2700 can operate in the capacity of a server machine or a client machine in a server-client network environment, or as a peer machine in a peer-to-peer (or distributed) network environment. The machine 2700 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2716, sequentially or otherwise, that specify actions to be taken by the machine 2700. Further, while only a single machine 2700 is illustrated, the term “machine” shall also be taken to include a collection of machines 2700 that individually or jointly execute the instructions 2716 to perform any one or more of the methodologies discussed herein.

The machine 2700 can include processors 2710, memory/storage 2730, and I/O components 2750, which can be configured to communicate with each other such as via a bus 2702. In an example implementation, the processors 2710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 2712 and a processor 2714 that can execute the instructions 2716. The term “processor” is intended to include multi-core processors that can comprise two or more independent processors (sometimes referred to as “cores”) that can execute instructions contemporaneously. Although FIG. 27 shows multiple processors 2710, the machine 2700 can include a single processor with a single core, a single processor with multiple cores (e.g., a multi-core processor), multiple processors with a single core, multiple processors with multiples cores, or any combination thereof.

The memory/storage 2730 can include a memory 2732, such as a main memory, or other memory storage, and a storage unit 2736, both accessible to the processors 2710 such as via the bus 2702. The storage unit 2736 and memory 2732 store the instructions 2716 embodying any one or more of the methodologies or functions described herein. The instructions 2716 can also reside, completely or partially, within the memory 2732, within the storage unit 2736, within at least one of the processors 2710 (e.g., within the processor's cache memory), or any suitable combination thereof, during execution thereof by the machine 2700. Accordingly, the memory 2732, the storage unit 2736, and the memory of the processors 2710 are examples of machine-readable media.

As used herein, “machine-readable medium” means a device able to store instructions (e.g., instructions 2716) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 2716. The term “machine-readable medium” shall also be taken to include any medium, or combination of multiple media, that is capable of storing instructions (e.g., instructions 2716) for execution by a machine (e.g., machine 2700), such that the instructions, when executed by one or more processors of the machine (e.g., processors 2710), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 2750 can include a wide variety of components to receive input, provide output, produce output, transmit information, exchange information, capture measurements, and so on. The specific I/O components 2750 that are included in a particular machine will depend on the type of machine. For example, portable machines such as mobile phones will likely include a touch input device or other such input mechanisms, while a headless server machine will likely not include such a touch input device. It will be appreciated that the I/O components 2750 can include many other components that are not shown in FIG. 27. The I/O components 2750 are grouped according to functionality merely for simplifying the following discussion and the grouping is in no way limiting. In various example implementations, the I/O components 2750 can include output components 2752 and input components 2754. The output components 2752 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2754 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 2750 can include biometric components 2756, motion components 2758, environmental components 2760, or position components 2762, among a wide array of other components. For example, the biometric components 2756 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2758 can include acceleration sensor components (e.g., accelerometer), gravitation sensor components, rotation sensor components (e.g., gyroscope), and so forth. The environmental components 2760 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 2762 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 2750 can include communication components 2764 operable to couple the machine 2700 to a network 2780 or devices 2770 via a coupling 2782 and a coupling 2772, respectively. For example, the communication components 2764 can include a network interface component or other suitable device to interface with the network 2780. In further examples, the communication components 2764 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2770 can be another machine or any of a wide variety of peripheral devices (e.g., a peripheral device coupled via a USB).

Moreover, the communication components 2764 can detect identifiers or include components operable to detect identifiers. For example, the communication components 2764 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 2764, such as location via Internet Protocol (IP) geolocation, location via Wi-Fi® signal triangulation, location via detecting an NFC beacon signal that can indicate a particular location, and so forth.

In various example implementations, one or more portions of the network 2780 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 2780 or a portion of the network 2780 can include a wireless or cellular network and the coupling 2782 can be a Code Division Multiple Access (CDMA) connection, a Global System for Mobile communications (GSM) connection, or another type of cellular or wireless coupling. In this example, the coupling 2782 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 27G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 2716 can be transmitted or received over the network 2780 using a transmission medium via a network interface device (e.g., a network interface component included in the communication components 2764) and utilizing any one of a number of well-known transfer protocols (e.g., HTTP). Similarly, the instructions 2716 can be transmitted or received using a transmission medium via the coupling 2772 (e.g., a peer-to-peer coupling) to the devices 2770. The term “transmission medium” shall be taken to include any intangible medium that is capable of storing, encoding, or carrying the instructions 2716 for execution by the machine 2700, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform one or more operations comprising:
receiving a first media content item;
associating one or more metadata tags with the first media content item;
based on at least one of the one or more metadata tags, selecting the first media content item for presentation at a first holographic presentation device;
transmitting the selected first media content item and a content presentation file associated with the first holographic presentation device, to the first holographic presentation device;
receiving one or more inputs corresponding to a presentation of the first media content item via the first holographic presentation device; and
based on the received one or more inputs, adjusting one or more aspects of a transmission of a second media content item to the first holographic presentation device.

2. The system of claim 1, wherein associating one or more metadata tags further comprises applying one or more acoustic recognition techniques to the first media content item.

3. The system of claim 1, wherein associating one or more metadata tags further comprises applying one or more digital watermarking techniques to the first media content item.

4. The system of claim 1, wherein associating one or more metadata tags further comprises applying one or more acoustic recognition techniques and one or more digital watermarking techniques to the first media content item.

5. The system of claim 1, wherein associating one or more metadata tags further comprises editing one or more metadata tags previously associated with the first media content item.

6. The system of claim 1, wherein selecting the first media content item comprises selecting the first media content item for presentation at a first holographic presentation device based on one or more aspects of the first holographic presentation device.

7. The system of claim 1, wherein the content presentation file comprises a driver associated with the first holographic presentation device.

8. The system of claim 1, wherein transmitting the selected first media content item comprises transmitting the selected first media content item together with a third media content item as injected into the first media content item, to the first holographic presentation device.

9. The system of claim 1, wherein receiving one or more inputs comprises receiving one or more inputs originating from a sensor positioned proximate to the presentation of the first media content item via the first holographic presentation device.

10. The system of claim 1, wherein receiving one or more inputs comprises processing one or more inputs originating from the first holographic presentation device to determine one or more capabilities of the first holographic presentation device.

11. The system of claim 1, wherein adjusting one or more aspects of a transmission of a second media content item comprises processing the received one or more inputs to determine one or more aspects of the presentation of the first media content item via the first holographic presentation device.

12. A method comprising:
receiving a first media content item;
associating one or more metadata tags with the first media content item;
based on at least one of the one or more metadata tags, selecting the first media content item for presentation at a first holographic presentation device;
transmitting the selected first media content item and a content presentation file associated with the first holographic presentation device, to the first holographic presentation device;
receiving one or more inputs corresponding to a presentation of the first media content item via the first holographic presentation device; and
based on the received one or more inputs, adjusting one or more aspects of a transmission of a second media content item to the first holographic presentation device.

13. The method of claim 12, wherein associating one or more metadata tags further comprises applying one or more acoustic recognition techniques to the first media content item.

14. The method of claim 12, wherein associating one or more metadata tags further comprises applying one or more digital watermarking techniques to the first media content item.

15. The method of claim 12, wherein associating one or more metadata tags further comprises applying one or more acoustic recognition techniques and one or more digital watermarking techniques to the first media content item.

16. The method of claim 12, wherein associating one or more metadata tags further comprises editing one or more metadata tags previously associated with the first media content item.

17. The method of claim 12, wherein selecting the first media content item comprises selecting the first media content item for presentation at a first holographic presentation device based on one or more aspects of the first holographic presentation device.

18. The method of claim 12, wherein the content presentation file comprises a driver associated with the first holographic presentation device.

19. The method of claim 12, wherein transmitting the selected first media content item comprises transmitting the selected first media content item together with a third media content item as injected into the first media content item, to the first holographic presentation device.

20. The method of claim 12, wherein receiving one or more inputs comprises receiving one or more inputs originating from a sensor positioned proximate to the presentation of the first media content item via the first holographic presentation device.

21. The method of claim 12, wherein receiving one or more inputs comprises processing one or more inputs originating from the first holographic presentation device to determine one or more capabilities of the first holographic presentation device.

22. The method of claim 12, wherein adjusting one or more aspects of a transmission of a second media content item comprises processing the received one or more inputs to determine one or more aspects of the presentation of the first media content item via the first holographic presentation device.

23. A non-transitory computer readable medium having instructions stored thereon that, when executed by a processing device, cause the processing device to perform one or more operations comprising:
receiving a first media content item;
associating one or more metadata tags with the first media content item;
based on at least one of the one or more metadata tags and one or more aspects of a first holographic presentation device, selecting the first media content item for presentation at the first holographic presentation device;
transmitting the selected first media content item and a content presentation file associated with the first holographic presentation device, to the first holographic presentation device, wherein the content presentation file comprises a driver associated with the first holographic presentation device;
receiving one or more inputs corresponding to a presentation of the first media content item via the first holographic presentation device; and
based on the received one or more inputs, adjusting one or more aspects of a transmission of a second media content item to the first holographic presentation device.
